(19) United States
(12) Patent Application Publication
(10) Pub. No.: US 2018/0215955 A1
(43) Pub. Date: Aug. 2, 2018

(54) REACTIVE ADHESIVE FILM SYSTEM FOR GLUING TOGETHER NON-POLAR SURFACES

(71) Applicant: TESA SE, Norderstedt (DE)

(72) Inventors: Elma CLARET, Aix-en-Provence (FR); Sebastian DIETZE, Hamburg (DE); Frank HANNEMANN, Hamburg (DE); Arne KOOPS, Neu-Lankau (DE); Uwe SCHÜMANN, Pinneberg (DE)

(73) Assignee: TESA SE, Norderstedt (DE)

(21) Appl. No.: 15/747,512

(22) PCT Filed: Jul. 5, 2016
(86) PCT No.: PCT/EP2016/065882

§ 371 Date: Jan. 25, 2018

(30) Foreign Application Priority Data
Jul. 31, 2015 (DE) 10 2015 009 764.4

(51) Int. Cl. C09J 7/10; C09J 7/40; C09J 5/02

(52) U.S. Cl. CPC C09J 7/10; C09J 2433/00; C09J 5/02; C09J 7/405

(57) ABSTRACT

Reactive adhesive film system, comprising a first reactive adhesive film (A) and a second reactive adhesive film (B); use of the reactive adhesive film system described herein for the bonding of materials with nonpolar surfaces; composites comprising the reactive adhesive film system; and methods for the production of the reactive adhesive film system and method for increasing the adhesive properties of the reactive adhesive film system on nonpolar substrates.

This is a 371 of PCT/EP2016/065882 filed 5 Jul. 2016, which claims foreign priority benefit under 35 U.S.C. 119 of German Patent Application 10 2015 009 764.4 filed Jul. 31, 2015, the entire contents of which are incorporated herein by reference.

The present invention concerns a reactive adhesive film system comprising a first reactive adhesive film (A) and a second reactive adhesive film (B); use of the reactive adhesive film system described herein for the bonding of materials with nonpolar surfaces; composites comprising the reactive adhesive film system; and methods for the production of the reactive adhesive film system.

A method for increasing the adhesive properties of the reactive adhesive film system on nonpolar substrates is also described.

### BACKGROUND OF THE INVENTION

Two-component adhesive systems have been known for many years and are extensively described in the technical literature. In these systems, an adhesive system composed of two components is applied to the parts to be bonded, with two liquid components ordinarily being used. However, such systems are disadvantageous because they are often applied by methods that are not sufficiently clean, and they are unsuitable for use in large-area bonding and on uneven surfaces in particular. Moreover, elevated temperatures are frequently required for activation of such adhesive systems, which is problematic, predominantly for temperature-sensitive substrates. Moreover, the storage stability of such liquid two-component adhesive systems is critical. In addition, vibrations after complete curing of conventional two-component adhesive systems often cause tearing or cracking in the bonded areas.

WO 2014/202402A1 addresses these problems by providing a reactive two-component adhesive system in film form. However, this adhesive system is also unsuitable for selective bonding of materials with nonpolar surfaces. In low-energy substrates such as polyethylene and polypropylene, therefore, adhesive failure between the substrate and the adhesive system occurs rapidly, as only low bonding strengths are observed.

WO 2012/152715A1 concerns strengthening of the adhesive properties of pressure-sensitive adhesives on substrates. For this purpose, the surface of a pressure sensitive adhesive layer is treated prior to bonding with a substrate plasma. However, it is observed in WO 2012/152715A1 that there is no increase in the adhesive properties of the plasma-treated pressure-sensitive adhesive on nonpolar substrates such as polyethylene or polypropylene.

Against this backdrop, there is a need for adhesive systems that provide increased bonding strength on nonpolar surfaces such as polyethylene or polypropylene.

### SUMMARY OF THE INVENTION

In order to solve this problem, the present invention proposes a reactive adhesive film system having a first reactive adhesive film (A) and a second reactive adhesive film (B), wherein at least one outer side of the first reactive adhesive film (A) and/or the second reactive adhesive film (B) is plasma-treated.

Provision of the adhesive film system in film form ensures ease of handling. In particular, slipping in use on the substrates to be bonded is prevented, and more precise bonding than in liquid adhesive systems becomes possible. Plasma treatment of the at least one outer side of the first reactive adhesive film (A) and/or the second reactive adhesive film (B) provides surprisingly high bonding strength of the adhesive system described herein on nonpolar surfaces such as polyethylene or polypropylene.

### DETAILED DESCRIPTION

The present invention concerns a reactive adhesive film system, comprising: at least one first reactive adhesive film (A), with (a) a polymeric film-forming matrix, (b) at least one reactive monomer or reactive resin, and (c) an initiator, in particular a radical initiator; and at least one second reactive adhesive film (B), with (a) a polymeric film-forming matrix, (b) at least one reactive monomer or reactive resin, and (c) an activator; wherein the first and the second reactive adhesive film each have an outer side and an inner side, and the inner side of the first reactive adhesive film is in contact or can be brought into contact with the second reactive adhesive film; and wherein the outer side of at least a first and/or a second reactive adhesive film is plasma-treated. This plasma-treated outer side is intended to adhesively bond to the surface of a material, preferably a nonpolar surface of a material such as polyethylene or polypropylene.

Surprisingly, it was found that by means of the plasma treatment of the outer side of at least a first and/or a second reactive adhesive film of the adhesive film system described herein, particularly favourable bonding strength can be obtained, even with respect to nonpolar surfaces such as polyethylene or polypropylene.

In a second aspect, the present invention therefore concerns use of the reactive adhesive film system as described herein for the bonding of various materials such as wood, metal, glass and/or plastics. In a preferred embodiment of the invention, the adhesive film system is used for the bonding of materials with nonpolar surfaces, preferably for the bonding of polyethylene or polypropylene. In a particularly preferred embodiment of the invention, the surface to be bonded, in particular the nonpolar surface to be bonded, of the material intended for bonding is also plasma-treated. Preferably, this plasma-treated surface of said material bonds to the plasma-treated outer side of the first and/or second reactive adhesive film of the reactive adhesive film system of the present invention.

In a further aspect, the present invention thus concerns composites comprising the reactive adhesive film system of the invention described herein. A “composite” as used herein is any three-dimensional article in which the reactive adhesive film system according to the invention is bonded to the surface of an article to be bonded via a plasma-treated outer side of a first reactive adhesive film (A) or via a plasma-treated outer side of a second reactive adhesive film (B). In a preferred aspect, the present invention concerns composites in which the plasma-treated outer side of the at least one reactive adhesive film is in contact with a plasma-treated surface of the article to be bonded, i.e., the surface of the material to be bonded to the plasma-treated outer side of the reactive adhesive film has been bonded in such a way as to allow adhesion to occur. The surface in contact with the plasma-treated outer side of the at least one reactive adhesive film is preferably a nonpolar surface such as polyethylene or polypropylene.

Surprisingly, it was found that high bonding forces also occur with respect to nonpolar surfaces when the plasma-treated outer side of the at least one reactive adhesive film is brought into contact with this nonpolar surface. Without wishing to be limited by this theoretical observation, the inventors assume that the high bonding strength with respect to nonpolar surfaces is possibly attributable to covalent bonding between the surface to be bonded and the plasma-treated outer side of the reactive adhesive film (A) or (B). These bonds appear to be sufficiently strong to prevent adhesion failure, i.e. detachment of the bonds in the area of the substrate/adhesive film system interface. At the same time, the reactive adhesive film system described herein, after the adhesive films (A) and (B) are brought into contact via their inner sides, forms a network of bonds that extend throughout the entire adhesive film system. This imparts particular strength to the reactive adhesive film system, so that cohesive failure, i.e. failure of the adhesive matrix, is also suppressed. Instead, the adhesive bond that can be achieved by means of the reactive adhesive film system is so stable that even in bonding of nonpolar materials such as polyethylene or polypropylene it is the bonded nonpolar materials themselves, such as polyethylene or polypropylene, which show material failure.

Finally, a further aspect of the present invention concerns a method for the production of the reactive adhesive film system according to the invention comprising the following steps.
(i) Provision of at least one first reactive adhesive film (A) with (a) a polymeric film-forming matrix, (b) at least one reactive monomer or reactive resin, and (c) an initiator, in particular a radical initiator;
(ii) provision of at least one second reactive adhesive film (B), with (a) a polymeric film-forming matrix, (b) at least one reactive monomer or reactive resin, and (c) an activator; and
(iii) plasma treatment of an outer side of the at least a first reactive adhesive film (A) and/or a second reactive adhesive film (B).

In a preferred embodiment of the invention, the plasma-treated outer side of the at least one first reactive adhesive film (A) and/or the at least one second reactive adhesive film (B) is intended to be brought into contact with the surface, particularly with a nonpolar surface of the substrate to be bonded.

In a further preferred embodiment, steps (i) and (ii), i.e. the steps of preparing the reactive adhesive films (A) and (B), comprise the following substeps.
a. Dissolving and/or fine distribution of the ingredients in one or a plurality of solvent(s) and/or water,
b. mixing of the dissolved or finely dispersed ingredients,
c. coating of a separating liner or paper, a substrate material, or a pressure-sensitive adhesive with the mixture of dissolved or dispersed ingredients of step b,
d. evaporation of the solvent and/or water, and
e. optionally, winding of the reactive adhesive film into a roll,

wherein the ingredients in step (i) comprise a polymeric film-forming matrix (a), at least one reactive monomer or reactive resin (b), an initiator, particularly a radical initiator (c), and optionally further additives and/or auxiliary materials; and wherein the ingredients in step (ii) comprise a polymeric film-forming matrix (a), at least one reactive monomer or reactive resin (b), an activator (c), and optionally further additives and/or auxiliary materials.

Particularly preferably, step (iii) is carried out using atmospheric pressure plasma.

In the following, the components of the adhesive film system according to the invention and further aspects of the present invention will be described in greater detail.

### Polymeric Film-Forming Matrix

The adhesive films according to the invention basically consist of a matrix, referred to below as a polymeric film-forming matrix, which contains the reactive monomers to be polymerized and/or reactive resins. The purpose of this matrix is to form an inert basic structure for the reactive monomers and/or adhesive resins so that they are not—as in the prior art—in a liquid state and thus capable of causing the above-mentioned problems, but are incorporated into a film or a foil. In this way, simpler handling is ensured.

In this context, inert means that the reactive monomers and/or reactive resins essentially do not react with the polymeric film-forming matrix under suitable selected conditions (e.g. at sufficiently low temperatures).

Suitable film-forming matrices for use in the present invention are preferably selected from the following list: a thermoplastic polymer such as a polyester or copolyester, a polyamide or copolyamide, a polyacrylic acid ester, an acrylic acid ester copolymer, a polymethacrylic acid ester, a methacrylic acid ester copolymer, thermoplastic polyurethanes, and chemically or physically crosslinked substances of the above-mentioned compounds. Blends of various thermoplastic polymers can also be used.

Moreover, elastomers and thermoplastic elastomers are also conceivable, either individually or in mixtures, as a polymeric film-forming matrix. Thermoplastic polymers, particularly those which are semi-crystalline, are preferred.

Particularly preferred are thermoplastic polymers with softening temperatures lower than 100° C. In this connection, the term softening point refers to the temperature from which the thermoplastic granules bond to themselves. In cases in which the component of the polymeric film-forming matrix is a semicrystalline thermoplastic polymer, it should most preferably, in addition to its softening temperature (which is connected with melting of the crystallites), have a maximum glass transition temperature of 25° C., and preferably a maximum of 0° C.

In a preferred embodiment of the invention, a thermoplastic polyurethane is used. The thermoplastic polyurethane preferably has a softening temperature below 100° C., and in particular less than 80° C.

In a particularly preferred embodiment of the invention, Desmomelt 530®, which is commercially available from Bayer Material Science AG, 51358 Leverkusen, Germany, is used as a polymeric film-forming matrix. Desmomelt 530® is a hydroxyl-terminated, largely linear, thermoplastic, strongly crystallizing polyurethane elastomer.

According to the invention, the amount of the polymeric film-forming matrix contained in the reactive adhesive is in the range of approx. 20-80 wt. %, preferably approx. 30-50 wt. %, relative to the total mixture of components of the reactive adhesive film. At the most, 35-45 wt. %, and preferably approx. 40 wt. % of the polymeric film-forming matrix is used relative to the total mixture of components of the reactive adhesive film. Here, the total mixture of components of the reactive adhesive film refers to the total amount of the polymeric film-forming matrix (a), the reactive monomers or reactive resins (b), the reagent (c), and further optionally present components used, which is obtained as a total (in wt. %). “Reagent (c)” is understood within the scope of the present invention to refer to an initiator, particularly a radical initiator, in the case of a first reactive adhesive film (A) and an activator in the case of a second reactive adhesive film (B).

### Reactive Monomer or Reactive Resin

As used herein, the reactive monomer or reactive resin represents a monomer or resin, which in particular is capable of radical chain polymerization.

According to the invention, a suitable reactive monomer is selected from the group of acrylic acids, acrylic acid esters, methacrylic acid, methacrylic acid esters, vinyl compounds, and/or oligomeric or polymeric compounds with carbon-carbon double bonds.

In a preferred embodiment, the reactive monomer is one or more representative compounds selected from the group composed of: methylmethacrylate (CAS No. 80-62-6), methacrylic acid (CAS No. 79-41-4), cyclohexyl methacrylate (CAS No. 101-43-9), tetrahydrofurfuryl methacrylate (CAS No. 2455-24-5), 2-phenoxyethylmethacrylate (CAS No. 10595-06-9), di-(ethylene glycol)methyl ether methacrylate (CAS No. 45103-58-0) and/or ethylene glycol dimethacrylate (CAS No. 97-90-5).

In a further preferred embodiment of the invention, the reactive adhesive film contains a mixture of cyclohexyl methacrylate, tetrahydrofurfuryl methacrylate, methacrylic acid, and ethylene glycol dimethacrylate as reactive monomers to be polymerized.

In a further preferred embodiment of the invention, the reactive adhesive film contains a mixture of methylmethacrylate, methacrylic acid and ethylene glycol -dimethacrylate as reactive monomers to be polymerized.

In a further preferred embodiment of the invention, the reactive adhesive film contains a mixture of 2-phenoxyethylmethacrylate and ethylene glycol dimethacrylate as reactive monomers to be polymerized.

In a further preferred embodiment of the invention, the reactive adhesive film contains a mixture of di-(ethylene glycol)methyl ether methacrylate and ethylene glycol dimethacrylate as reactive monomers to be polymerized.

As (a) reactive resin(s), oligomeric mono-, di-, tri- and higher-functionalized (meth)acrylates may be selected. It is highly advantageous to use these in a mixture with at least one reactive monomer.

According to the invention, each of these preferred embodiments can be combined with a thermoplastic polyurethane such as Desmomelt 530® as a polymeric film-forming matrix.

According to the invention, the amount of the reactive monomer/reactive monomers of the reactive resin/reactive resins contained in the reactive adhesive film is in the range of approx. 20-80 wt. %, preferably approx. 40-60 wt. %, relative to the total mixture of components of the reactive adhesive film. The highest amount used is preferably approx. 40-50 wt.% of the reactive monomer/reactive monomers of the reactive resin/reactive resins relative to the total mixture of components of the reactive adhesive film. Here the total mixture of components of the reactive adhesive film refers to the total amount of the polymeric film-forming matrix (a), the reactive monomers or reactive resins (b), the reagent (c), and further optionally present components used, which is obtained as a total (in wt. %). Here “reagent (c)” represents an initiator, in particular a radical initiator, in the case of a first reactive adhesive film, (A) and represents an activator in the case of a second reactive adhesive film (B).

### Initiator, in Particular Radical Initiator

As used herein, the term initiator, in particular a radical initiator or radical-forming substance (or a curing agent), refers to a compound that can initiate a polymerization reaction or crosslinking of the adhesive. The initiator, in particular a radical initiator, participates only minimally in the reaction and therefore does not give rise to any of the properties of the polymer component to be bonded.

In the present invention an initiator, in particular a radical initiator, is added to the at least one first reactive adhesive film of the adhesive film system.

Radical initiators are preferred. All radical initiators known in the prior art may be used. Preferred radical initiators are peroxides, hydroperoxides, and azo compounds.

In a particularly preferred embodiment of the invention, the radical initiator is an organic peroxide. Particularly preferred is dimethylbenzyl hydroperoxide, also known as cumene hydroperoxide (CAS No. 80-15-9).

According to the invention, the amount of the radical initiator contained in a reactive adhesive film is in the range of approx. 3-30 wt. %, and preferably approx. 8-15 wt. %, relative to the total mixture of components of the reactive adhesive film. Preferably, a maximum of approx. 9-11 wt. % of the radical initiator is used relative to the total mixture of components of the reactive adhesive film. Here, the total mixture of components of the reactive adhesive film refers to the entire amount of the polymeric film-forming matrix (a), the reactive monomers or reactive resins (b), the reagent (c), and further optionally present components used, which is obtained as a total (in wt. %). Here, “reagent (c)” again represents an initiator, particularly a radical initiator, in the case of a first reactive adhesive film (A) and an activator in the case of a second reactive adhesive film (B).

### Activator

As used here, the term activator refers to a compound which at only very low concentrations permits or accelerates the process of polymerization. Activators can also be referred to as accelerators or accelerating agents.

In the present invention, an accelerator is added to the at least one second reactive adhesive film (B) of the adhesive film system.

Suitable activators for use in the present invention, if a radically polymerizable system is to be activated, are selected, for example, from the group consisting of: an amine, a dihydropyridine derivative, a transition metal salt, or a transition metal complex. In particular, tertiary amines are used for activating the radical-forming substance.

In a particularly preferred embodiment of the invention, the activator is 3,5-diethyl-1,2-dihydro-1-phenyl-2-propylpyridine (also referred to as PDHP, CAS No. 34562-31-7).

According to the invention, the amount of the above-described activators in the second reactive adhesive film (B) ranges from greater than 0 to approx. 40 wt. %, and preferably approx. 15-25 wt. %, relative to the total mixture of components of the reactive adhesive film. Preferably, a maximum of approx. 16-22 wt. %, and even more preferably 18-20 wt. % activator is used relative to the total mixture of components of the reactive adhesive film. Here, the total mixture of components of the reactive adhesive film refers to the total amount of the polymeric film-forming matrix (a), the reactive monomers or reactive resins (b), the reagent (c), and further optionally present components used, which is obtained as a total (in wt. %).

In a further embodiment of the present invention, the activator comprises a transition metal complex selected from the group of a manganese(II) complex, an iron(II) complex or a cobalt(II) complex, in each case with a compound selected from porphyrin, porphyrazine or phthalocyanine or a derivative of one of these compounds as a ligand. According to the invention, the amount of the activator contained in these transition metal complexes is preferably in the range of more than 0 to approx. 10 wt. %, and preferably approx. 0.1-5.0 wt. %. The maximum amount used is preferably approx. 0.2-3.0 wt. %, and even more preferably 0.5-2.0 wt. % of the activator relative to the total mixture of components of the reactive adhesive film. Here, the total mixture of components of the reactive adhesive film refers to the total amount of the polymeric film-forming matrix (a), the reactive monomers or reactive resins (b), the reagent (c), and further optionally present components, which is obtained as a total (in wt. %).

### Further Components of the Reactive Adhesive Film

The reactive adhesive films of the present invention may optionally contain further additives and/or auxiliary materials known in the prior art. Examples include fillers, colourants, nucleating agents, rheological additives, blowing agents, adhesion-enhancing additives (adhesion promoters, tackifier resins), compounding agents, plasticizers, and/or anti-aging, light and UV stabilizers, for example in the form of primary and secondary antioxidants.

### Compositions of Preferred Reactive Adhesive Films

In a preferred embodiment of the invention, the at least one first adhesive film (A) comprises a mixture of the following components: thermoplastic polyurethane, particularly Desmomelt 530®, cyclohexyl methacrylate, tetrahydrofurfuryl methacrylate, methacrylic acid, ethylene glycol dimethacrylate, and cumene hydroperoxide.

In a further preferred embodiment of the invention, the at least one first adhesive film (A) comprises a mixture of the following components: thermoplastic polyurethane, particularly Desmomelt 530®, methylmethacrylate, methacrylic acid, ethylene glycol di methacrylate, and cumene hydroperoxide.

In a further preferred embodiment of the invention, the at least one first adhesive film (A) comprises a mixture of the following components: thermoplastic polyurethane, particularly Desmomelt 530®, 2-phenoxyethylmethacrylate, ethylene glycol dimethacrylate, and cumene hydroperoxide.

In a further preferred embodiment of the invention, the at least one first adhesive film (A) comprises a mixture of the following components: thermoplastic polyurethane, particularly Desmomelt 530®, di-(ethylene glycol)methyl ether methacrylate, ethylene glycol dimethacrylate, and cumene hydroperoxide.

Each of these preferred embodiments of the invention contains approx. 20-80 wt. % of thermoplastic polyurethane, approx. 20-80 wt. % of reactive monomer(s), and approx. 3-30 wt. % of cumene hydroperoxide, preferably approx. 30-50 wt. % of thermoplastic polyurethane, approx. 40-60 wt. % of reactive monomers, and approx. 8-15 wt. % of cumene hydroperoxide relative to the total mixture of components of the reactive adhesive film.

In a preferred embodiment of the invention, the at least one second adhesive film (B) comprises a mixture of the following components: thermoplastic polyurethane, particularly Desmomelt 530®, cyclohexyl methacrylate, tetrahydrofurfuryl methacrylate, methacrylic acid, ethylene glycol dimethacrylate, and PDHP.

In a further preferred embodiment of the invention, the at least one second adhesive film (B) comprises a mixture of the following components: thermoplastic polyurethane, particularly Desmomelt 530®, methylmethacrylate, methacrylic acid, ethylene glycol dimethacrylate, and PDHP.

In a further preferred embodiment of the invention, the at least one second adhesive film (B) comprises a mixture of the following components: thermoplastic polyurethane, particularly Desmomelt 530®, 2-phenoxyethylmethacrylate, ethylene glycol dimethacrylate, and PDHP.

In a further preferred embodiment of the invention, the at least one second adhesive film (B) comprises a mixture of the following components: thermoplastic polyurethane, particularly Desmomelt 530®, di-(ethylene glycol)methyl ether methacrylate, ethylene glycol dimethacrylate, and PDHP.

Each of these preferred embodiments of the invention contains approx. 20-80 wt. % of thermoplastic polyurethane, approx. 20-80 wt. % of reactive monomer(s), and more than 0 to approx. 40 wt. % of PDHP, preferably approx. 30-50 wt. % of thermoplastic polyurethane, approx. 40-60 wt. % of reactive monomer(s), and approx. 15-25 wt. % of PDHP relative to the total mixture of components of the reactive adhesive film.

As used herein, the total mixture of components of the reactive adhesive film refers to the total amount of the polymeric film-forming matrix (a), the reactive monomer/monomers and/or the reactive resin/resins (b), the reagent (c), and further optionally present components, which is obtained as a total (in wt. %).

Other preferred examples of the at least one second reactive adhesive film (B) comprise the following mixtures:
a mixture of thermoplastic polyurethane, particularly Desmomelt 530®, 2-phenoxyethylmethacrylate, 2-hydroxyethylmethacrylate, 2-hydroxypropylmethacrylate, ethylene glycol dimethacrylate, and iron(II)-phthalocyanine;
a mixture of thermoplastic polyurethane, particularly Desmomelt 530®, 2-phenoxyethylmethacrylate, 2-hydroxyethylmethacrylate, ethylene glycol dimethacrylate, and iron(II)-phthalocyanine.

The reactive adhesive films (A) and (B) of the invention basically have, independently of each other, one layer each in the range of approx. 20-200 μm, preferably approx. 30-100 μm, more preferably approx. 40-60 μm, and particularly preferably approx. 50 μm. For the production of greater layer thicknesses, it can be advantageous to laminate a plurality of adhesive film layers together.

The reactive adhesive film according to the invention (A) and/or (B) is also characterized by preferably having pressure-sensitive adhesive properties. According to Rompp, pressure-sensitive adhesive substances are defined as viscoelastic adhesives (Rompp Online 2013, Document Identification No. RD-08-00162) whose cured, dry film is permanently tacky and retains adhesiveness at room temperature. Pressure-sensitive adhesion occurs immediately on almost all substrates through application of light contact pressure. Here, light contact pressure refers to contact pressure of more than 0 bar applied for a duration longer than 0 seconds.

### Reactive Adhesive Film System

According to the invention, the first and second reactive adhesive film (A) and (B), as described above, are used for the reactive adhesive film system, which is characterized in that the first reactive adhesive film (A), in addition to the film-forming matrix (a) and at least one reactive monomer or reactive resin (b), contains an initiator, in particular a radical initiator, and the second reactive adhesive film (B), in addition to the film-forming matrix (a) and at least one reactive monomer or reactive resin (b), contains an activator.

It is of decisive importance that at least one outer side of the first reactive adhesive film (A) and/or the second reactive adhesive film (B) be plasma-treated. The term “outer side” as used herein refers to the side of the first or second reactive adhesive film (A) or (B) which is opposite to the inner side of said adhesive film, with the inner side serving as a contact surface between the first reactive adhesive film (A) and the second reactive adhesive film (B).

In other words, at least one reactive adhesive film of the adhesive film system according to the invention has a plasma-treated outer side available for bonding to a material, preferably for bonding to a material with a nonpolar surface.

The side of the plasma-treated adhesive film facing away from the plasma-treated side (e.g. film (A)), i.e. the “inner side” of the plasma-treated adhesive film (e.g. film (A)) is intended to serve as a contact surface for the other reactive adhesive film (i.e. film (B), if film (A) has a plasma-treated outer side). This means that one reactive adhesive film (A) and one reactive adhesive film (B) in the reactive adhesive film system of the present invention are in contact with each other via their inner sides.

The reactive adhesive film system according to the invention also comprises two or more reactive adhesive films as defined above. If more than only one first reactive adhesive film (A) and/or more than one second reactive adhesive film (B) are present in the adhesive film system, the two or more reactive adhesive films (A) and/or (B) are preferably alternating, so that each adhesive film (A) is in contact with at least one adhesive film (B).

The first and the second reactive adhesive film (A) and (B) undergo crosslinking and curing as soon as they are brought into extensive contact with each other under moderate pressure, particularly 0.5 to 3 bar, at temperatures in the range of room temperature to 100° C. In particular, said moderate temperature should be achievable by manual means. According to the invention, the contact time is a few minutes to hours, depending on temperature. The pressure may be mechanically or manually applied.

If the two reactive adhesive films (A) and (B), as described above, are previously applied to the substrates to be bonded, the above-described crosslinking gives rise to permanent bonding of the substrates. Alternatively, adhesive film (A) can also be first applied to the first substrate to be bonded, after which adhesive film (B) is applied to adhesive film (A). The second substrate to be bonded is then applied to adhesive film (B).

The reactive adhesive film system of the invention may also comprise substrates, i.e. release paper or release liner.

### Substrates

Suitable substrates for bonding by means of the reactive adhesive film system according to the invention are metals, glass, wood, concrete, stone, ceramics, textiles, and/or plastics. The substrates to be bonded may be the same or different.

In a preferred embodiment, the reactive adhesive film system according to the invention is used for the bonding of materials with nonpolar surfaces. The terms “nonpolar surface” or “low-energy surface” as used herein refer to surfaces having a lower free surface energy than that of polyethylene terephthalate (PET). Preferred low-energy surfaces show a lower free surface energy than PET, whose free surface energy is 40.9 mN/m, with the energy of the dispersed component of PET preferably being 37.8 and that of the polar component of PET being 3.1 mN/m. In a particularly preferred embodiment of the invention, ethylene-propylene-diene rubber (EPDM), polyethylene (PE), polypropylene (PP), and/or polytetrafluoroethylene (PTFE) are bonded.

Suitable metal substrates to be bonded can generally be produced from all common metals and metal alloys. Preferably, metals such as aluminium, stainless steel, steel, magnesium, zinc, nickel, brass, copper, titanium, ferrous metals, and alloys are used. Moreover, the components to be bonded may be composed of different metals.

Further examples of suitable plastic substrates include acrylonitrile-butadiene-styrene-copolymers (ABS), polycarbonate (PC), ABS/PC blends, PMMA, polyamide, glass fibre-reinforced polyamide, polyvinylchloride, polyvinylene fluoride, cellulose acetate, cycloolefin copolymers, liquid crystal polymers (LCPs), polylactide, polyether ketone, polyether imide, polyether sulfone, polymethacrylmethylimide, polymethyl pentene, polyphenyl ether, polyphenylene sulfide, polyphthalamide, polyurethane, polyvinylacetate, styrene-acrylonitrile copolymers, polyacrylate or polymethacrylate, polyoxymethylene, acrylic ester-styrene-acrylonitrile copolymers, polyethylene, polystyrene, polypropylene, and/or polyesters such as polybutylene terephthalate (PBT) and/or polyethylene terephthalate (PET).

Substrates may be painted, printed, vapour-treated, or sputtered.

The reactive adhesive film systems according to the invention allow high bonding strength to be achieved, even on nonpolar surfaces. Preferably, the adhesive film system according to the invention is therefore used in applications in which the plasma-treated outer side of the at least one first and/or second reactive adhesive film is brought into contact with a nonpolar surface and bonded.

The substrates to be bonded may be in any desired form required for the use of the resulting composite. In the simplest form, the substrates are flat. Moreover, three-dimensional substrates, which for example are inclined, can also be bonded using the reactive adhesive film system according to the invention. The substrates to be bonded can be used for widely differing functions, such as housings, viewing windows, stiffening elements, etc.

In a preferred embodiment of the invention, the reactive adhesive film system described herein is used for the bonding of nonpolar surfaces. In this case, the plasma-treated outer side of a reactive adhesive film is brought into contact with the nonpolar surface of the substrate to be bonded. If two nonpolar substrates are bonded to each other, both outer sides of the reactive adhesive films available for bonding are preferably plasma-treated in the reactive adhesive film system.

In a further preferred embodiment of the invention, the low-energy surface of the nonpolar substrate(s) to be bonded is also plasma-treated.

Method for the production of a reactive adhesive film system

The reactive adhesive film system according to the invention can be produced by a method comprising the following steps (i) to (iii):
(i) provision of at least one first reactive adhesive film (A) with (a) a polymeric film-forming matrix, (b) at least one reactive monomer or reactive resin, and (c) an initiator, in particular a radical initiator;
(ii) provision of at least one second reactive adhesive film (B), with (a) a polymeric film-forming matrix, (b) at least one reactive monomer or reactive resin, and (c) an activator; and
(iii) plasma treatment of an outer side of at least a first reactive adhesive film (A) and/or a second reactive adhesive film (B).

Here, the reactive adhesive films (A) and (B) can be produced for steps (i) and (ii) by means of the process steps specified in claim 16 as substeps a. to e. These substeps can be described as follows:

In a first step, the ingredients are dissolved in one or a plurality of solvent(s) and/or water, or finely dispersed. Alternatively, no solvent and/or water is needed, as the ingredients are already fully soluble in one another (optionally under the action of heat and/or shearing). Suitable solvents are known in the prior art, wherein solvents are preferably used in which at least one of the ingredients shows favourable solubility. Acetone is particularly preferred.

As used herein, the term ingredient comprises the polymeric film-forming matrix, at least one reactive monomer or reactive resin, a reagent (“reagent (c)”) selected from an initiator, in particular a radical initiator or an activator, and optionally, further additives and/or auxiliary materials as defined above.

After this, the dissolved or finely dispersed ingredients are mixed in one second step. Ordinary stirring devices are used for production of the mixture. Optionally, the solution is also heated. Optionally, the ingredients may be simultaneously dissolved or finely distributed and mixed.

Next, in a third step, a release paper, a substrate material, or a pressure-sensitive adhesive is coated with the mixture of the dissolved or finely dispersed ingredients of step 2. This coating is carried out using the usual technical methods known in the prior art.

After coating, the solvent is removed by evaporation in a fourth step.

Optionally, the reactive adhesive film can be wound into a roll in a further step.

For storage, the reactive adhesive films according to the invention are covered with a release liner or paper.

Alternatively, the reactive adhesive films according to the invention are produced solvent-free by extrusion, hot melt nozzle coating, or calendering.

Prior to the bonding of the reactive adhesive film system according to the invention, the outer side of the at least one first and/or second reactive adhesive film ((A), (B)) is plasma-treated.

### Use of the Reactive Adhesive Film System

The reactive adhesive film system according to the invention is typically used as follows:

The at least one first adhesive film (A) is applied to the surface of a substrate to be bonded. In addition, the at least one second adhesive film (B) is applied to a surface of a second substrate to be bonded. In this manner, the side applied to the surface of the substrate to be bonded (outer side) of the first and/or second reactive adhesive film is subjected to plasma pretreatment. If nonpolar, i.e. low-energy surfaces, preferably polyethylene or polypropylene, are used in bonding, the plasma-treated outer side of a reactive adhesive film (A) or (B), preferably (A), is preferably brought into contact with this surface. Particularly preferably, the surface, preferably the low-energy surface of the substrate, via which the substrate is in contact or is to be brought into contact with the plasma-treated outer side of the reactive adhesive film (A) or (B), is also plasma-treated.

After application of the adhesive films (A) and (B) to the substrates to be bonded via their outer sides, the adhesive films (A) and (B) are brought into contact with each other via their inner sides and remain in contact for pressing times in the range of a few minutes to several hours at temperatures ranging from room temperature to 100° C., which causes the polymerization reaction to begin and the adhesive to be cured. Alternatively, for example, the at least one second adhesive film (B) can also be applied to the first adhesive film (A) and only then applied to the surface of a second substrate to be bonded.

Optionally, the above-described method can be repeated in order to achieve bonding of the layers substrate-(A)-(B)-(A)-(B)-substrate, substrate-(B)-(A)-(B)-substrate, substrate-(A)-(B)-(A)-substrate, etc. This can be advantageous in cases where there are differences in the extent of the adhesive properties between the substrates to be bonded and the first and second adhesive films (A) and (B).

According to the invention, the plasma-treated outer side of the at least one plasma-treated reactive adhesive film (A) or (B) is brought into contact with a nonpolar surface of an article to be bonded, if such a nonpolar surface is bonded.

### Composite

Finally, the invention provides a composite comprising the reactive adhesive film system according to the invention, as defined above.

### Plasma Treatment

In plasma treatment of an outer side of the at least one first and/or second reactive adhesive film (A) or (B), the plasma is preferably applied by means of one or a plurality of nozzle(s) to the side of the reactive adhesive film to be treated, preferably under operation with compressed air or N₂. If the substrate surface to be bonded is also to be subjected to plasma treatment, plasma treatment of the substrate can be carried out in the same manner. Specifically, plasma is applied to the side of the substrate to be bonded, preferably by means of one or a plurality of nozzle(s), and preferably under operation with compressed air or N₂.

Particularly preferably, the plasma is applied by means of a rotary nozzle, particularly preferably under operation with compressed air or N₂.

Modern indirect plasma methods are often based on a nozzle design. In this case, the nozzle can be configured in round or linear form, and in some cases rotary nozzles are used, without this being intended to constitute a limitation. Such a nozzle design is advantageous because of its flexibility and the inherently one-sided treatment. Such nozzles, such as those manufactured by Plasmatreat, are in widespread industrial use for the pretreatment of substrates prior to bonding. Disadvantages are the treatment method, which is indirect and less efficient because it is discharge-free, and the reduced web speeds. However, the conventional design of a round nozzle is particularly suitable for treating narrow webs such as an adhesive tape with a width of a few cm.

A variety of plasma generators are available on the market, differing in plasma generation technology, nozzle geometry, and gas atmosphere. Although the treatment methods used differ in factors such as efficiency, the basic effects are usually similar and are determined primarily by the gas atmosphere used. Plasma treatment can take place in various atmospheres, and the atmosphere may also comprise air. The treatment atmosphere can comprise a mixture of different gases, selected for example from N₂, O₂, H₂, CO₂, Ar, He, and ammonia, and water vapour or other components can be mixed in. This list is given by way of example and does not limit the invention.

According to an advantageous embodiment of the invention, the following process gases, either in pure or mixed form, form a treatment atmosphere: N₂, compressed air, O₂, H₂, CO₂, Ar, He, ammonia, and ethylene, and water vapour or other volatile components may also be added. Preferred are N₂ and compressed air.

In principle, coating or polymerizing components can also be mixed into the atmosphere in the form of a gas (for example ethylene) or liquids (atomized as an aerosol). There is virtually no limit on the number of suitable aerosols. Indirectly operating plasma methods are particularly well suited for the use of aerosols, as there is no risk of contamination of the electrodes in such methods.

As the effects of plasma treatment are of a chemical nature and primarily involve modification of the surface chemistry, the above-described methods can also be described as physicochemical treatment methods. Although there may be differences in the details, no particular technology is to be emphasized within the meaning of the invention, neither with respect to plasma generation nor construction form.

Furthermore, the plasma jet is preferably applied by rotating the nozzle tip. The plasma jet then passes over the substrate at a predetermined angle in a circle and advantageously provides a favourable treatment width for adhesive tapes. Because of the rotation, the treatment jet passes over the same areas multiple times, depending on the operating speed, i.e. carries out repeated treatment by definition.

Another preferred variant of plasma treatment is the use of a fixed plasma jet without a rotary nozzle.

A further preferred plasma treatment uses a lateral arrangement of several nozzles, staggered if necessary, for seamless, partially overlapping treatment over a sufficient width. The disadvantage in this case is the required number of nozzles, as two to four non-rotary round nozzles are typically used rather than one rotary nozzle.

The structure of a round nozzle is generally preferred for the bonding of narrow adhesive tapes. However, linear nozzles are also suitable.

According to a further advantageous embodiment of the invention, the treatment distance is 1 to 100 mm, preferably 3 to 50 mm, and particularly preferably 4 to 20 mm.

More preferably, the treatment speed is 0 to 200 m/min, preferably 1 to 50 m/min, and particularly preferably 2 to 20 m/min.

Particularly preferred is universal treatment by means of a rotary nozzle with a distance of 9 to 12 mm between the nozzle and the surface to be treated and with relative lateral movement between the nozzle and substrate of 4 to 6 m/min.

Of course, the treatment must be carried out within a range in which the gas is reactive, or within a distance (for example from a nozzle) at which the gas is still reactive. In the case of a nozzle, this range comprises the effective range of the plasma jet.

Plasma treatment of the surface can also be carried out multiple times.

Treatment can be carried out multiple times in succession in order to achieve the desired intensity, and this is always the case in the preferred rotary treatment or in partially overlapping nozzle arrangements.

For example, the required treatment intensity can be achieved by means of several passes under one nozzle or the configuration of multiple successive nozzles. Repeated treatment can also be used as a refresher treatment. It is also possible for the treatment to be divided into several individual treatments.

The time point is not specified, but should preferably be shortly before bonding.

In treatment directly before bonding, the time interval for bonding can be <1 second, in inline treatment before bonding in the range of seconds to minutes, in offline-treatment in the range of hours to days, and in treatment in a manufacturing process of the adhesive tape in the range of days to several months.

As is the case for most physical treatment methods, the effect of the plasma treatment can subside over time. However, this depends to a great extent on the details of treatment and the adhesive tape in question. Obviously, even during a possible decrease in treatment effect, adhesion remains superior compared to an untreated state. In principle, the improved adhesion over this period of time also constitutes part of the teaching herein.

In principle, treatment may be carried out or refreshed in the form of repeated treatment. The term “plasma-treated” as used in connection with the outer side of the adhesive film system described herein thus means that the adhesion-increasing action of the plasma treatment has not yet fully disappeared.

The time interval between repeated treatments can thus range from approx. 0.1 seconds (during rotation of the nozzle) to approx. one year (when a product is supplied after being treated, with a refresher treatment before use).

The treatment can be carried out in-line with the bonding.

There are no restrictions on the number of individual nozzles or other plasma generators used in treatment.

There is no limit on the number of individual treatments carried out with the plasma generator(s).

For example, pretreatment of the surface with a specified plasma generator would be conceivable, said treatment being supplemented or refreshed at a later time using a different plasma generator.

Moreover, the surface could first be treated by means of a flame or corona method before being treated by the method presented herein. For example, plastic components or films are sometimes subjected by the manufacturer to physical pretreatment.

In a variant of the invention, the plasma is applied using a plasma nozzle unit with additional introduction of a precursor material into the working gas flow or the plasma jet. In this case, application may be conducted at staggered intervals or simultaneously.

The atmospheric pressure plasma method (and surface treatment by means thereof) is substantially different from the corona discharge method (and surface treatment by means thereof). For the purposes of the present invention, the corona discharge method described in further detail below also refers to “plasma-treated” surfaces. In other words, the outer side of the first or second adhesive film can also be treated by the corona discharge method in order to obtain a plasma-treated outer surface.

Corona treatment is defined as a surface treatment using filament discharge by means of high alternating current between two electrodes, wherein discrete discharge channels impinge on the surface to be treated, cf. Wagner et al., Vacuum, 71 (2003), pp. 417 to 436. Unless otherwise stated, the process gas is assumed to be ambient air.

In almost all cases, the substrate is placed or fed through a discharge chamber between an electrode and a counter electrode, which is defined as “direct” physical treatment. Web-shaped substrates are typically fed between an electrode and an earthed roller.

In particular, the term “corona” is generally understood to mean “dielectric barrier discharge.” In this case, at least one of the electrodes consists of a dielectric, i.e. an insulator, or is coated or covered with such a dielectric.

The intensity of a corona treatment is indicated as a “dose” in [Wmin/m²], with dose D=P/b*v, P=electric powder [W], b=electrode width [m], and v=web speed [m/min].

In almost every case, the substrate in the discharge chamber is placed or guided between an electrode and a counter electrode, which is defined as “direct” physical treatment. Web-shaped substrates are typically guided between an electrode and an earthed roller. The terms “blown-out corona” or “one-sided corona” are also sometimes used. This is not comparable to the atmospheric pressure plasma method, because as a rule, only irregular discharge filaments are “blown out” together with a process gas, and stable, well-defined, efficient treatment is often impossible.

“Atmospheric pressure plasma” is defined as an electrically activated, homogenous, reactive gas that is not in thermal equilibrium at a pressure close to ambient pressure. The gas is activated and highly excited states are generated by the electric discharges and ionization processes in the electrical field. The gas or gas mixture used is referred to as process gas. In principle, coating or polymerizing components may also be added as a gas or aerosol to the plasma atmosphere.

The term “homogeneous” indicates that there are no discrete, non-homogeneous discharge channels impinging on the surface of the substrate (although they may be present in the generating chamber).

The restriction “not in thermal equilibrium” means that the ion temperature can be distinguished from the electron temperature. In the case of a thermally generated plasma, these temperatures would be in balance (also cf. for example Akishev et al., Plasmas and Polymers, Vol. 7, No. 3, September 2002).

In physical treatment of a surface by the atmospheric pressure plasma method, the electrical discharge usually takes place in a chamber separate from the surface. The process gas is then fed through this chamber, electrically activated, and then usually directed onto the surface as plasma, usually through a nozzle. The reactivity of the plasma jets generally decreases rapidly after exiting, in spatial terms typically from millimetres to centimetres. This plasma of decreasing reactivity is often referred to in English as “afterglow.” The service life and usable section of the exiting plasma depends on molecular details and the exact nature of plasma generation.

This type of physical treatment is referred to as “indirect” if the treatment does not take place at the site where the electrical discharges are produced. Treatment of the surface is carried out at or close to atmospheric pressure, but the pressure in the electrical discharge chamber can be elevated.

For example, however, approaches for carrying out indirect plasma treatments are also known in which the electrical discharges take place in a gas flow outside of a nozzle and also provide a plasma jet treatment.

Equally well known are homogeneous atmospheric pressure plasmas in which the treatment takes place in a discharge chamber, referred to as homogeneous glow discharge at atmospheric pressure (“glow discharge plasma,” cf. for example T Yokoyama et al., 1990, J. Phys. D: Appl. Phys. 23 1125).

Components of the atmospheric pressure plasma may be:
Highly excited atomic states
Highly excited molecular states
Ions
Electrons
Unmodified components of the process gas.

It is preferred to use conventional commercial systems to generate atmospheric pressure plasma. The electrical discharges may take place between metal electrodes, but also between metal and a dielectric, or be generated by piezoelectric discharge or other methods. A few examples of commercial systems are Plasma-Jet (Plasmatreat GmbH,

Germany), PlasmaBlaster (Tigres GmbH, Germany), Plasmabrush and Piezobrush (Reinhausen, Germany), Plasmaline (VITO, Belgium), or ApJet (ApJet, Inc., USA). These systems operate using different process gases such as air, nitrogen, or helium and have different resulting gas temperatures.

Preferred is the method of Plasmatreat GmbH (Steinhagen, Germany), described for example in the following quote from WO 2005/117507A2:

“A plasma source is known from prior art in EP 0761415A1 and EP1335641 A1 in which a plasma jet is generated in a nozzle tube, under application of a high-frequency high voltage, between a pin electrode and a ring electrode by means of non-thermal discharge from the working gas, with said plasma jet exiting the nozzle opening. At a suitably adjusted flow rate, this non-thermal plasma jet shows no electrical streamers, so that only the high-energy but low-temperature plasma jet can be directed onto the surface of a component. Here, streamers are the discharge channels along which the electrical discharge energy moves during discharge. The high electron temperature, low ion temperature, and high gas speed can also be mentioned as characteristics of the plasma jet.”

In a corona discharge according to the above definition, the high voltage applied causes filamentary discharge with accelerated electrons and ions to form. In particular, the light electrons strike the surface at great speed with energy levels that are sufficient to rupture most molecular bonds. The reactivity of the reactive gas components that also form usually has only a minor effect. The ruptured binding sites then react further with components of the air or the process gas. A decisive effect is the formation of short-chain decomposition products due to electron bombardment. In higher-intensity treatment, significant material degradation may also occur.

The reaction of a plasma with the substrate surface causes the plasma components to be directly “incorporated” to a stronger degree. Alternatively, an excited state and/or open bonding can be produced on the surface, followed by further secondary reactions, for example with atmospheric oxygen. For some gases, such as inert gases, no chemical bonding of the process gas atoms or molecules to the substrate is to be expected. In such cases, activation of the substrate takes place exclusively by means of secondary reactions.

The essential difference is therefore that in plasma treatment there is no direct action of discrete discharge channels on the surface.

The action of the plasma treatment as described herein preferably takes place homogeneously and gently, particularly via reactive gas components. In indirect plasma treatment, free electrons may be present, but not in accelerated form, as the treatment takes place outside the generating electrical field.

Plasma treatment is gentle and allows good wettability to be obtained with a long-term stable effect. It also has less of a destructive effect than corona treatment, as no discrete discharge channels affect the surfaces. There are fewer short-chain decomposition products that can form a layer on the surface that has a negative effect. Wettability can therefore often be achieved by plasma treatment that is superior to that of corona treatment, with a longer-lasting effect.

The inventors feel that the reduced chain decomposition and homogenous treatment achieved by using the plasma treatment method contribute substantially to the robustness and effectiveness of the method disclosed herein.

### Experimental Section

The following examples are intended to clarify the present invention, but are by no means to be interpreted as limiting the scope of protection in any way.

Analogously to example 1 of WO 2015/062809A1, adhesive films KF-B-P1 and KF-A-P1 are provided in order to prepare a reactive adhesive film system comprising a first reactive adhesive film (A) and a second reactive adhesive film (B). Prior to bonding of the adhesive film to the respective test piece—provided this is necessary and indicated in the following examples—plasma treatment is carried out, provided that surface treatment is planned for the respective experiment. For plasma treatment, a unit from Plasmatreat (OpenAir plasma RD 1004) is activated by means of compressed air via a rainbow-like discharge before the surface to be treated can be treated in the activated “afterglow” with a power of 1 kW, a treatment distance of 12 mm, and a speed of 5 m/min.

In order to determine tensile shear strength, the procedure of example 1 of WO 2015/062809A1 is used, wherein polypropylene produced by Total Petrochemicals (Finalloy HXN-86) and steel are selected as test pieces.

A total of six tests are conducted, with three repetitions each, using the following blank combinations A-B, in order to bond one polypropylene test piece each (“PPT”) with a steel test piece or a polypropylene test piece. The resulting composites are then tested for bonding strength. For example, “steel-(A)-(B)-PPT” indicates that the outer side of the first reactive adhesive film (A) was applied to steel, and that the outer side of the adhesive film (B) is in contact with the polypropylene test piece. The indication “*” in the following composites, for example, means that the side of the adhesive film bonded to the polypropylene test piece (“PPT*”) is plasma-treated. Similarly, (A*) or (B*) indicates plasma treatment of the outer sides of the respective adhesive film:
(1) PPT-(A)-(B)-PPT
(2) PPT-(A*)-(B)-steel
(3) PPT-(A*)-(B)-PPT
(4) PPT-(A*)-(B*)-PPT*
(5) PPT-(A*)-(B)- (A*)-PPT*
(6) steel-(A)-(B*)-PPT*

In tests (4) and (5), pure substrate failure of the polypropylene test pieces is observed. In tests (2) and (6), adhesion failure is observed in the area of the (B)-steel bonds or steel-(A) bonds. In test, (1) failure of the bond between the polypropylene test pieces and the adhesive films (A) and (B) occurs. Thus in this example, no bonding whatsoever occurs. Accordingly, the bond (B)-PPT* in example (3) also fails.

1. Reactive adhesive film system, comprising at least one first reactive adhesive film (A), with (a) a polymeric film-forming matrix, (b) at least one reactive monomer or reactive resin, and (c) a radical initiator; and
at least one second reactive adhesive film (B), with (a) a polymeric film-forming matrix, (b) at least one reactive monomer or reactive resin, and (c) an activator;
wherein the first and the second reactive adhesive films each have an outer side and an inner side, and the inner side of a first reactive adhesive film is in contact or can be brought into contact with a second reactive adhesive film;
and wherein the outer side of the at least one first and/or second reactive adhesive film is plasma-treated.

2. Reactive adhesive film system according to claim 1, wherein the polymeric film-forming matrix (a) in the first and/or the second reactive adhesive film is a thermoplastic polymer, or an elastomer or a thermoplastic elastomer; and/or the reactive monomer (b) in the first and/or the second reactive adhesive comprises at least one representative selected from the group consisting of acrylic acid, acrylic acid ester, methacrylic acid, methacrylic acid esters and vinyl compounds, and/or oligomeric or polymeric compounds with carbon-carbon double bonds

3. Reactive adhesive film system according to claim 1, wherein the first and/or the second reactive adhesive film has pressure-sensitive properties.

4. Reactive adhesive film system according to claim 1, wherein the radical initiator is a peroxide.

5. Reactive adhesive film system according to claim 1, wherein the activator is an amine, a dihydropyridine derivative, a transition metal salt, or a transition metal complex.

6. Reactive adhesive film system according to claim 5, wherein the activator comprises as a ligand a transition metal complex selected from the group consisting of a manganese(II) complex, an iron(II) complex, and a cobalt(II) complex, in each case with a compound selected from the group consisting of porphyrin, porphyrazine, phthalocyanine derivatives thereof.

7. Reactive adhesive film system according to claim 1, wherein the first reactive adhesive film (A) comprises: 20-80 wt. % of a polymeric film-forming matrix (a), 20-80 wt. % of at least one reactive monomer (b), and 3-30 wt. % of a radical initiator (c).

8. Reactive adhesive film system according to claim 1, wherein the second reactive adhesive film (B) comprises: 20-80 wt. % of a polymeric film-forming matrix (a), 20-80 wt. % of at least one reactive monomer (b), and more than 0 to 40 wt. % of an activator (c).

9. Reactive adhesive film system according to claim 1, comprising two or more first reactive adhesive films (A) and/or two or more second reactive adhesive films (B), wherein the first and second reactive adhesive films are arranged in an overlapping configuration.

10. Reactive adhesive film system according to claim 1, comprising release paper and/or release liner.

11. A method for the bonding of materials selected from the group consisting of metal, wood, glass and plastics, wherein said materials are bonded with the reactive adhesive film system of claim 1.

12. Method of claim 11 wherein said materials are materials with nonpolar surfaces, wherein the nonpolar surface to be bonded is also plasma-treated.

13. Composite, bonded by means of the reactive adhesive film system according to claim 1.

14. Composite according to claim 13, in which the plasma-treated outer side of the at least one reactive adhesive film is in contact with a plasma-treated nonpolar surface.

15. Method for the production of a reactive adhesive film system according to claim 1, wherein the method comprises the following steps:
(i) provision of at least one first reactive adhesive film (A) with (a) a polymeric film-forming matrix, (b) at least one reactive monomer or reactive resin, and (c) a radical initiator;
(ii) provision of at least one second reactive adhesive film (B) with (a) a polymeric film-forming matrix, (b) at least one reactive monomer or reactive resin, and (c) an activator; and
(iii) plasma or corona treatment of an outer side of the at least one first reactive adhesive film (A) and/or second reactive adhesive film (B).

16. Method according to claim 15, wherein the steps (i) and (ii) of providing the reactive adhesive films (A) and (B) comprise the following substeps:
a. dissolving and/or fine distribution of the ingredients in one or a plurality of solvent(s) and/or water,
b. mixing of the dissolved or finely dispersed ingredients,
c. coating of a release liner or paper, a substrate material, or a pressure-sensitive adhesive with the mixture of dissolved or dispersed ingredients of step b,
d. evaporation of the solvent and/or water, and
e. optionally, winding of the reactive adhesive film into a roll,
wherein the ingredients in step (i) comprise a polymeric film-forming matrix (a), at least one reactive monomer or reactive resin (b), and a radical initiator (c), and optionally, further additives and/or auxiliary materials; and wherein the ingredients in step (ii) comprise a polymeric film-forming matrix (a), at least one reactive monomer or reactive resin (b), as well as an activator (c), and optionally, further additives and/or auxiliary materials.

17. Method according to claim 15, wherein step (iii) is carried out at atmospheric pressure.
